(19) United States
(12) Patent Application Publication
(10) Pub. No.: US 2014/0056449 A1
(43) Pub. Date: Feb. 27, 2014

(54) STACKED PIEZOELECTRIC SPEAKER DEVICE

(71) Applicant: WISOL CO., LTD., Osan-si (KR)

(72) Inventors: Yukihiro NORO, Suwon-si (KR); Sang Sub ROH, Osan-si (KR); Yun Kwon CHOI, Ansan-si (KR)

(73) Assignee: WISOL CO., LTD., Osan-si (KR)

(21) Appl. No.: 13/621,884

(22) Filed: Sep. 18, 2012

(30) Foreign Application Priority Data
Aug. 24, 2012 (KR) 10-2012-0093046

(51) Int. Cl. H04R 17/00

(52) U.S. Cl. 381/190

(57) ABSTRACT

A stacked piezoelectric speaker device having a structure where a piezoelectric ceramic plate and an internal electrode plate are stacked, in which an inactive dummy electrode is disposed around an active internal electrode on the same layer to ensure uniform plastic shrinkage. The stacked piezoelectric speaker device has a structure in which an inactive dummy electrode that does not contribute to polarization is disposed around an active internal electrode that contributes to the polarization, the active internal electrode and the inactive dummy electrode being stacked on the same layer.

### CROSS-REFERENCE TO RELATED PATENT APPLICATION

This application claims the benefit of Korean Patent Application No, 10-2012-0093046, filed on Aug. 24, 2012, in the Korean Intellectual Property Office, the disclosure of which is incorporated herein in its entirety by reference.

### BACKGROUND OF THE INVENTION

1. Field of the Invention

The present invention relates to a piezoelectric speaker device, in which a piezoelectric ceramic plate and an electrode plate are stacked, and more particularly, to a stacked piezoelectric speaker device, in which an inactive dummy electrode is disposed around an active internal electrode to ensure uniform sintering shrinkage, thus preventing deformation of a piezoelectric speaker.

2. Description of the Related Art

In general, a piezoelectric element refers to an element that has the capability of converting between electrical energy and mechanical energy, and a piezoelectric speaker is a product that produces sound at a desired frequency by converting the mechanical movement of the piezoelectric element via a vibration plate. Here, the piezoelectric element generates a voltage by a force applied to a piezoelectric ceramic plate, and the magnitude of the generated voltage varies depending on the magnitude of the force.

A typical piezoelectric speaker comprises a piezoelectric element and a vibration plate which is larger than the piezoelectric element and bonded to one side of the piezoelectric element to amplify the vibration generated at the piezoelectric element. The acoustic properties of the piezoelectric element are determined by the sound pressure at each frequency, and the sound pressure at each frequency may vary depending on the material and properties of the vibration plate.

Typically, a high-performance piezoelectric speaker provides high output, has a high sound pressure at each frequency, and has a flat and wide sound range. The vibration plate applied to the piezoelectric speaker is mainly made of metals, polymers, pulp, etc.

FIG. 5 is a diagram showing the structure of a conventional stacked piezoelectric speaker.

As shown in FIG. 5, a conventional stacked piezoelectric speaker has a structure in which a first external electrode is disposed on the top, a second external electrode is disposed on the bottom, a first terminal electrode and a third terminal electrode, which are connected to an external electrode other than the first external electrode, and a second terminal electrode, which is connected to an internal electrode, are further disposed on the top, and a piezoelectric ceramic plate and an internal electrode are alternately stacked between the top and bottom.

However, according to the conventional stacked piezoelectric speaker having the above-described structure, the layer in which the internal electrode comprises a part with the internal electrode and a part without the internal electrode, each having different shrinkage behavior, and therefore the deformation of a product occurs.

### Prior Art Literature

Patent Literature: Korean Patent No. 1,152,23 (issued May 25, 2012).

### SUMMARY OF THE INVENTION

The present invention has been made in an effort to solve the above-described problems associated with prior art, and an object of the present invention is to provide a stacked piezoelectric speaker device having a structure where a piezoelectric ceramic plate and an internal electrode plate are stacked, in which an inactive dummy electrode is disposed around an active internal electrode on the same layer to ensure uniform sintering shrinkage, thus preventing the deformation of a piezoelectric speaker.

In one aspect, the present invention provides a stacked piezoelectric speaker device having a structure in which an inactive dummy electrode that does not contribute to polarization is disposed around an active internal electrode that contributes to the polarization.

The active internal electrode and the inactive dummy electrode may be stacked on the same layer between piezoelectric ceramic plates.

The active internal electrode and the inactive dummy electrode may be stacked on the same layer, in which a first active internal electrode and a first inactive dummy electrode may be disposed on a first piezoelectric ceramic plate, a first external electrode may be disposed below the first piezoelectric ceramic plate, a second piezoelectric ceramic plate may be disposed above the first active internal electrode and the first inactive dummy electrode, a second active internal electrode and a second inactive dummy electrode may be disposed above the second piezoelectric ceramic plate, a third piezoelectric ceramic plate may be disposed above the second active internal electrode and the second inactive dummy electrode, and a second external electrode may be disposed above the third piezoelectric ceramic plate.

The first piezoelectric ceramic plate, the second piezoelectric ceramic plate, and the third piezoelectric ceramic plate may be stacked such that the polarization directions are opposite to each other.

The inactive dummy electrodes may be made of the same material as the active internal electrodes.

The material for the active internal electrodes and the inactive dummy electrodes may be silver (Ag) or silver-palladium (Ag—Pd).

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram showing an example of a stacked piezoelectric speaker device in accordance with an exemplary embodiment of the present invention;

FIG. 2 is a diagram showing an example of a structure to which a stacked piezoelectric speaker device in accordance with an exemplary embodiment of the present invention is applied;

FIGS. 3A to 3C show cross-section I views of a stacked piezoelectric speaker device in accordance with an exemplary embodiment of the present invention;

FIG. 4 is a graph showing the sintering shrinkage rate of products depending on the presence and absence of an internal electrode; and

FIG. 5 is a diagram showing the structure of a conventional stacked piezoelectric speaker.

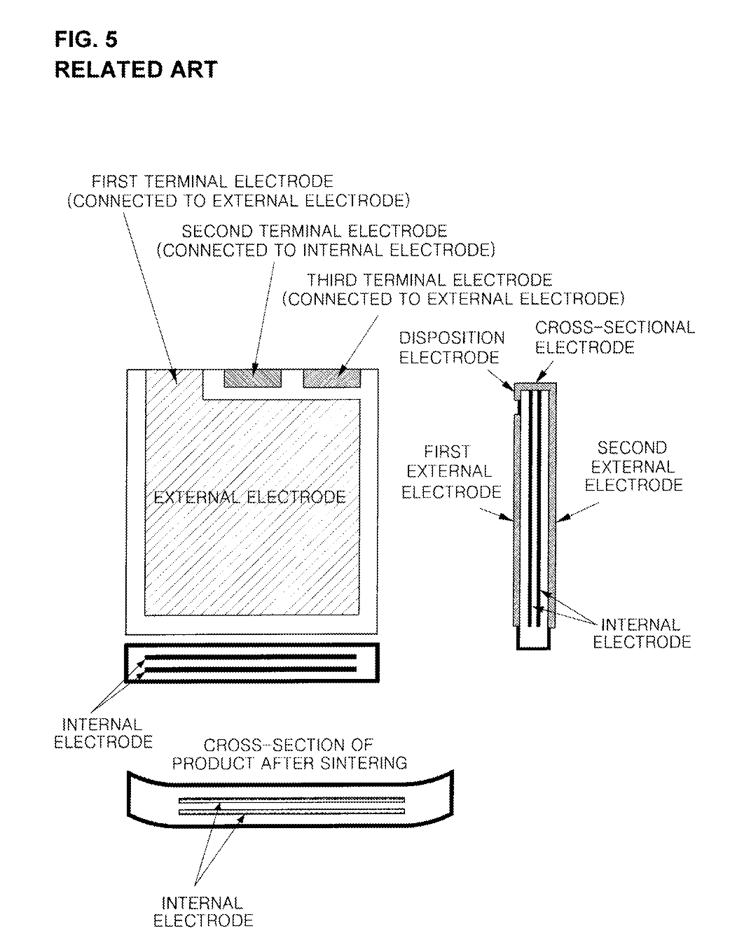

### DETAILED DESCRIPTION OF THE INVENTION

Hereinafter, exemplary embodiments of a stacked piezoelectric speaker device according to the present invention will be described in detail with reference to the accompanying drawings, in which the same reference numerals are used to designate the same or similar components and a repetitive description thereof will be omitted.

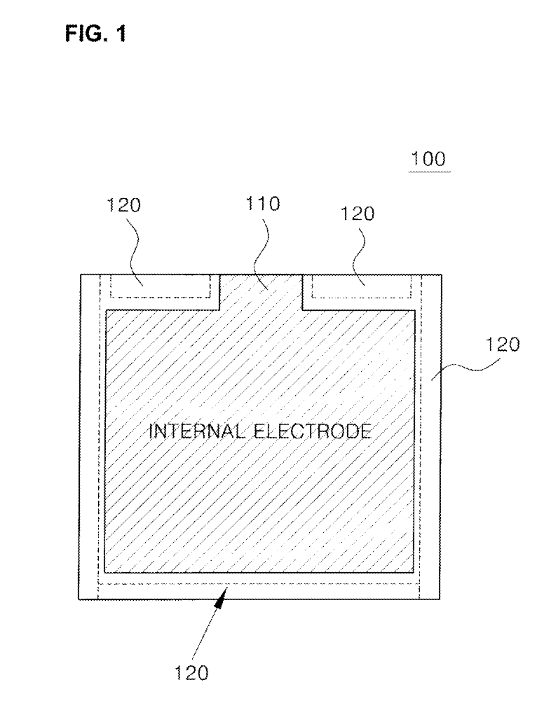

FIG. 1 is a diagram showing an example of a stacked piezoelectric speaker device in accordance with an exemplary embodiment of the present invention.

Referring to FIG. 1, a stacked piezoelectric speaker device 100 in accordance with an exemplary embodiment of the present invention has a structure in which an inactive dummy electrode 120 that does not contribute to polarization is disposed around an active internal electrode 110 that contributes to the polarization.

Here, the active internal electrode 110 and the inactive dummy electrode 120 are stacked on the same layer between piezoelectric ceramic plates.

Moreover, the inactive dummy electrode 120 is spaced a predetermined distance from the active internal electrode 110 to surround the active internal electrode 110.

Accordingly, when the layer in which the active internal electrode 110 and the inactive dummy electrode 120 coexist is sintered, it shows uniform shrinkage behavior (sintering shrinkage), thus preventing the deformation of a product.

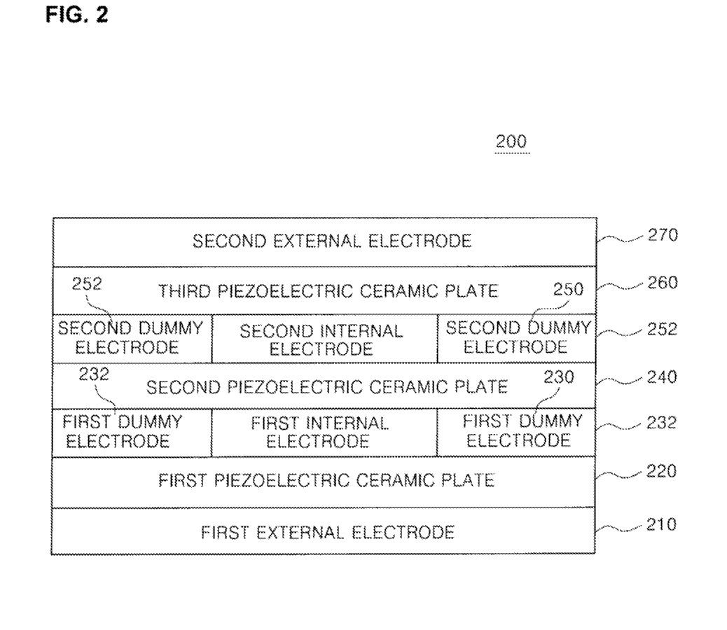

FIG. 2 is a diagram showing an example of a structure to which a stacked piezoelectric speaker device in accordance with an exemplary embodiment of the present invention is applied.

Referring to FIG. 2, a structure 200 to which a stacked piezoelectric speaker device in accordance with an exemplary embodiment of the present invention is applied includes the active internal electrode 110 and the inactive dummy electrode 120, which are stacked on the same layer, in which a first active internal electrode 230 and a first inactive dummy electrode 232 are disposed on a first piezoelectric ceramic plate 220, a first external electrode 210 is disposed below the first piezoelectric ceramic plate 220, a second piezoelectric ceramic plate 240 is disposed above the first active internal electrode 230 and the first inactive dummy electrode 232, a second active internal electrode 250 and a second inactive dummy electrode 252 are disposed above the second piezoelectric ceramic plate 240, a third piezoelectric ceramic plate 260 is disposed above the second active internal electrode 250 and the second inactive dummy electrode 252, and a second external electrode 270 is disposed above the third piezoelectric ceramic plate 260.

Moreover, the first piezoelectric ceramic plate 220, the second piezoelectric ceramic plate 240, and the third piezoelectric ceramic plate 260 are stacked in a manner that the first piezoelectric ceramic plate 220 and the third piezoelectric ceramic plate 260 are polarized in the same direction and the second piezoelectric ceramic plate 240 is not polarized.

Furthermore, the inactive dummy electrodes 120, 232 and 252 may be made of the same material as the active internal electrodes 110, 230 and 250.

For example, the material for the active internal electrodes 110, 230 and 250 and the inactive dummy electrodes 120, 232 and 252 may be silver (Ag) or silver-palladium (Ag—Pd).

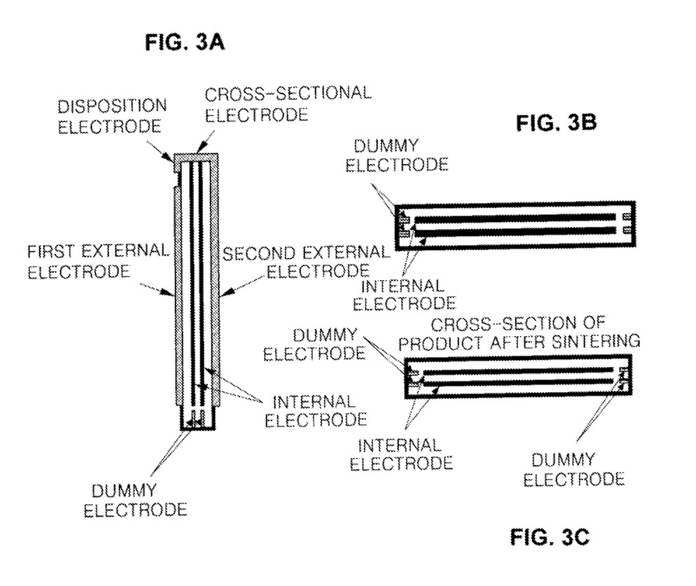

FIGS. 3A to 3C show cross-sectional views of a stacked piezoelectric speaker device in accordance with an exemplary embodiment of the present invention.

FIG. 3A is a cross-sectional view from a first side of the stacked piezoelectric speaker device according to the present invention, FIG. 3B is a cross-sectional view from a second side of the stacked piezoelectric speaker device according to the present invention, and FIG. 3C is a cross-sectional view of a product after sintering. As can be seen from FIGS. 3A and 3B, the dummy electrodes are disposed on the same layer as the internal electrodes to surround the internal electrodes.

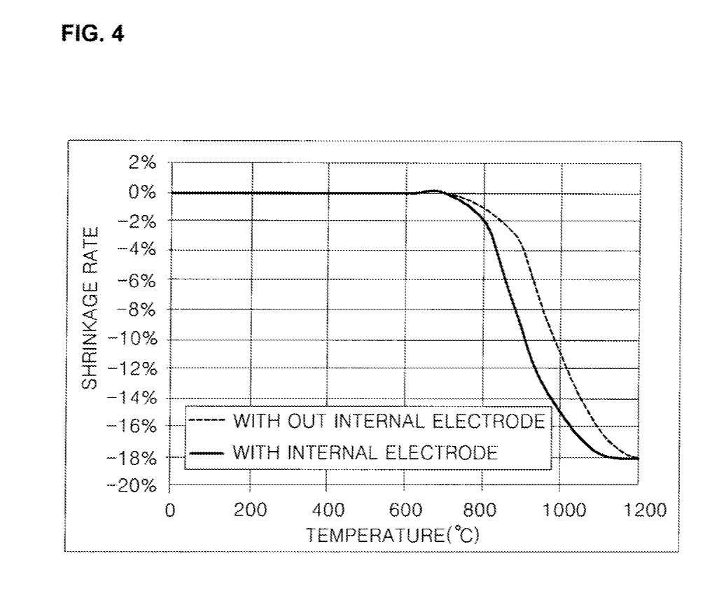

It can be seen from FIG. 4 showing the sintering shrinkage rate of products depending on the presence and absence of an internal electrode that the shrinkage occurs rapidly in the presence of the internal electrode and the shrinkage occurs slowly in the absence of the internal electrode, Accordingly, if there is no dummy electrode around the internal electrode, like the conventional piezoelectric speaker, the deformation of the product occurs. However, when the inactive dummy electrodes are disposed to surround the internal electrode according to the exemplary embodiment of the present invention, the shrinkage of the internal electrode and the dummy electrodes occurs at the same rate during sintering of the product, thus preventing the deformation of the product.

As described above, according to the stacked piezoelectric speaker device of the present invention, which has the structure where the piezoelectric ceramic plate and the internal electrode plate are stacked, the inactive dummy electrode is disposed around the active internal electrode on the same layer to ensure uniform sintering shrinkage, thus preventing the deformation of the piezoelectric speaker.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A stacked piezoelectric speaker device having a structure in which an inactive dummy electrode that does not contribute to polarization is disposed around an active internal electrode that contributes to the polarization.

2. The stacked piezoelectric speaker device of claim 1, wherein the active internal electrode and the inactive dummy electrode are stacked on the same layer between piezoelectric ceramic plates.

3. The stacked piezoelectric speaker device of claim 2, wherein the active internal electrode and the inactive dummy electrode are stacked on the same layer, in which a first active internal electrode and a first inactive dummy electrode are disposed on a first piezoelectric ceramic plate, a first external electrode is disposed below the first piezoelectric ceramic plate, a second piezoelectric ceramic plate is disposed above the first active internal electrode and the first inactive dummy electrode, a second active internal electrode and a second inactive dummy electrode are disposed above the second piezoelectric ceramic plate, a third piezoelectric ceramic plate is disposed above the second active internal electrode and the second inactive dummy electrode, and a second external electrode is disposed above the third piezoelectric ceramic plate.

4. The stacked piezoelectric speaker device of claim 1, wherein the inactive dummy electrodes are made of the same material as the active internal electrodes.

5. The stacked piezoelectric speaker device of claim 4, wherein the material for the active internal electrodes and the inactive dummy electrodes is silver (Ag) or silver-palladium (Ag—Pd).
